(19) United States
(12) Patent Application Publication
(10) Pub. No.: US 2025/0229205 A1
(43) Pub. Date: Jul. 17, 2025

(54) FILTER ELEMENT, FILTER DEVICE, VEHICLE, USE AND METHOD

(71) Applicant: MANN+HUMMEL GmbH, Ludwigsburg (DE)

(72) Inventors: Christian WEIGERT, Bindlach (DE); Peter PEKNY, Neuenmarkt (DE); Maximilian BAUCH, Bönnigheim (DE)

(21) Appl. No.: 19/171,500

(22) Filed: Apr. 7, 2025

Related U.S. Application Data
(63) Continuation of application No. PCT/EP2023/072367, filed on Aug. 14, 2023.

(30) Foreign Application Priority Data
Oct. 17, 2022 (DE) 102022127114.5

(51) Int. Cl. B01D 46/00; B01D 46/52

(52) U.S. Cl. CPC B01D 46/0005; B01D 46/0001; B01D 46/521; B01D 2265/028; B01D 2279/40

(57) ABSTRACT

A filter element has a filter medium body surrounded by a frame with two engagement elements arranged at a side face of the frame and extending away from the filter medium body that engage in a locked state with correlated engagement element counterparts at a filter housing. A rigid element connects the engagement elements to the side face. The engagement elements disengage the correlated engagement element counterparts in a released state and have a first distance to each other in the released state and a second distance to each other in the locked state that differs from the first distance. The engagement elements are connected by an elastic element to the rigid element. The elastic element, when the engagement elements transition from the locked into the released state, generates a restoring force acting on the engagement element.

### CROSS-REFERENCE TO RELATED APPLICATIONS

This application is a continuation application of international application No. PCT/EP2023/072367 having an international filing date of Aug. 14, 2023, and designating the United States, the international application claiming a priority date of Oct. 17, 2022, based on prior filed German patent application No. 10 2022 127 114.5, the entire contents of the aforesaid international application and of the aforesaid German patent application being incorporated herein by reference.

### BACKGROUND

The present invention concerns a filter element, for example for an interior filter device, for example, for a motor vehicle. Furthermore, the present invention concerns a filter device and a vehicle with such a filter device. Still further, the present invention concerns a use of such a filter element. According to yet another aspect, the present invention concerns a method for attachment of such a filter element at or in a filter housing.

Even though applicable to any filter elements and filter devices, the present invention as well the underlying problems will be described in the following for an interior filter of a motor vehicle.

The increasing air pollution, for example in metropolitan areas, in combination with the use of modern air conditioning devices makes it necessary to purify by means of suitable filters the processed as well as air-conditioned air which is guided in from the exterior into the interior of a motor vehicle. For example, particle filters, odor filters, or their combinations are conceivable for filtering or absorbing the aerosols, particulate matter, and odors contained in the ambient air.

For filtering air for the interior of a motor vehicle, often folded or pleated filter materials, for example, filter nonwovens that form a fold pack, are used. For this purpose, an initially flat filter material sheet is folded in a zigzag shape. The fold pack is held, for example, by lateral bands and head bands or another type of frame. Such filter elements may be fixed in a filter housing in an exchangeable manner. The thus formed filter device may be installed in an air conditioning device of a corresponding motor vehicle.

The exchange of filter elements should be performable as easily as possible. At the same time, the filter element should be fixed securely in the corresponding filter housing. This means that the filter element should not be moved out of its position in the filter housing, for example, by vibrations or pressure pulses. A further goal may reside in that only certain filter elements suitable for the respective application may be inserted into the filter housing.

For achieving these goals, it is generally known to provide filter elements and filter housings with suitable engagement elements and engagement element counterparts (or receiving means). In the fastened or mounted state, these elements provide a form fit that holds the respective filter element in the correlated filter housing. Examples of such engagement elements and engagement element counterparts may be, for example, screws with correlated threads or clips with correlated latches.

DE 10 2007 050 850 A1 describes an interior filter for a heating or air conditioning device of a motor vehicle.

WO 2015/086661 A1 discloses a filter element with a filter medium and a frame for fastening the filter medium at or in a filter receptacle. The frame includes at least one engagement element and at least one snap hook. The at least one engagement element may be brought into pivotable engagement with a receiving element of the filter receptacle for pivoting the filter element relative to the filter receptacle about a pivot axis. The at least one snap hook may be snapped in at least one latch in the filter receptacle for blocking a pivoting action of the filter element relative to the filter receptacle at least in a first direction about the pivot axis.

WO 2021/213869 A1 discloses an air filter device for a motor vehicle with a housing with a receptacle for a filter element, wherein the filter element includes a frame surrounding the filter material of the filter element at least in sections. Side walls of the frame are elastically deformable so that a distance of the two projections arranged at the same side wall relative to each other may be reduced in order to move, upon insertion of the filter element, respective second projections past inwardly oriented guide flanks into the second guide end region correlated with them.

### SUMMARY

According to a first aspect, a filter element, for example for an interior filter device, for example, for a motor vehicle, is proposed. The filter element may be fastened at or in a filter housing, wherein the filter element includes: a filter medium body, a frame surrounding at least partially the filter medium body, two engagement elements arranged at a side face of the frame and which extend away from the filter medium body and which may be brought into engagement with respectively correlated engagement element counterparts at the filter housing for attachment of the filter element at or in the latter, a rigid element which connects the two engagement elements at the side face in a force-conducting manner to each other, wherein the two engagement elements are configured to be disengaged in a released state thereof from the correlated engagement element counterparts and, in a locked state thereof, to be in engagement with them, wherein the two engagement elements in the released state include a first distance from each other and in the locked state a second distance from each other which is different from the first distance, wherein a first one of the two engagement elements at the side face is connected by means of an elastic element to the rigid element, wherein the elastic element upon transition of the two engagement elements between the locked state and the released state produces a restoring force acting on the first one of the two engagement elements.

The term “force-conductingly connected” is understood herein in that the rigid element is capable of transmitting a reaction force, which is directed opposite to the restoring force, between the two engagement elements. In embodiments, this is possible by a rigid element of a one-part or multi-part configuration.

In an embodiment the frame or the filter medium body must not be elastically deformed (even though this is not excluded) in order to mount the filter element at or in the filter housing. Instead, the corresponding elastic deformability is at least partially or exclusively provided by means of an elastic element which is connected mechanically between the first one of the engagement elements and the rigid element. Correspondingly, a force flow at the time when the restoring force is generated extends from the first one of the engagement elements through the elastic element, through the rigid element and then (optionally via another elastic element or directly) into the other engagement element. The first one of the engagement elements is connected to the rigid element by means of the elastic element and therefore is connected only indirectly thereto. The other engagement element may be directly but also indirectly connected to the rigid element. For example, it may also be provided that the two engagement elements (one engagement element in any case by means of the elastic element) each are connected to the frame, wherein the frame is reinforced only in sections by the rigid element, so that, for example, a section of a non-rigid frame material is located between the force introduction point of the corresponding engagement element at the side face and the rigid element. However, when this section is designed to be short, it will bend only to a small extent, for example, and is correspondingly not detrimental to the function.

One or a plurality of the engagement elements may be configured presently, for example, as pegs, projections, pins, beading etc. More than two engagement elements may be provided. For example, two engagement elements may be provided at two side faces of the frame, respectively. Correspondingly, also two or more engagement element counterparts are provided at the filter housing. For example, one (but also the other one) of the two engagement elements may be designed as a latch, wherein the corresponding engagement element is then designed as a counterpart latch.

The locked state corresponds to the mounted state (i.e., the filter element is fastened at or in the filter housing) of the filter element. In the locked state, a movement of the filter element in relation to the filter housing is blocked in all six degrees of freedom. That the two engagement elements are in engagement with the engagement element counterparts is to be understood such that they form a form fit with each other, respectively.

The released state corresponds to a state in which the engagement elements have just left the engagement with the engagement element counterparts. For example, the restoring force may be maximal in the released state. In this context, “maximal” corresponds to an observation period in which first the filter element and the filter housing are present separate from each other and, at its end, the filter element is fastened at or in the filter housing.

For conversion from the locked state into the released state, it may be for example required to apply a manual force on the filter element, for example on one of the two engagement elements or on both engagement elements. The manual force in this context may be applied either indirectly or directly to at least one of the engagement elements. Thus, during mounting it is thus possible, on the one hand, that a mounting force oriented in the insertion direction is exerted on the filter element which is then converted into a movement transverse to the insertion direction by an insertion section of the correlated housing-associated engagement element counterpart, which, for example, is embodied as an incline, in order to change the distance of the engagement elements relative to each other. On the other hand, for example for demounting, means that facilitate application of the manual force on the at least one engagement element or improve the accessibility by hand of the engagement elements may be provided at the filter element itself. For this purpose, for example, a lever, a band or a tab connected to at least one of the engagement elements is conceivable.

In other words, a rest state assumed by the engagement elements without external force load corresponds to their locked state. Due to the restoring force which is produced by the elastic element, the engagement element or engagement elements have the tendency to return automatically into the locked state upon conversion from the released state into the locked state.

The first distance may be larger or smaller than the second distance. This depends on the respective design. According to an embodiment, a difference between the first distance and the second distance amounts to less than about 20%, for example less than about 10%, and even further less than about 5% of the first distance. For example, in embodiments the difference of the distances is just enough so that at least the first one of the two engagement elements may be guided past the corresponding engagement element counterpart in order to disengage them from each other. For example, the difference of the distances between the first distance and the second distance may amount to less than about 15 mm, less than about 10 mm, or less than about 5 mm. For transitioning between the locked state and the released state, a movement of the engagement elements may be quasi away from each other or quasi toward each other.

The first one (and/or also the second one to be mentioned later on) of the two engagement elements may be designed to be pivoted or (also exclusively) linearly moved when transitioning between the locked state and the released state.

The elastic element is for example a spring and may be manufactured, for example, of plastic material and/or metal.

The engagement element counterparts may be formed at wall sections of the filter housing. The filter housing may be configured, for example, in the form of a frame, for example a rectangular frame. The wall sections may be partial regions of oppositely positioned sides of the frame. The filter housing may be manufactured, for example, of plastic material. For example, the filter housing may be manufactured as an injection molded plastic component. In addition or as an alternative, the filter housing may also be manufactured partially or completely of metal, for example sheet metal.

It is possible to provide (precisely) one side face, for example, in case of a filter element including a round or other free from without corners. It is also possible however to provide a plurality of, for example four, side faces. For example, two side faces may be positioned opposite each other. For example, two oppositely positioned side faces may be provided which each include two (or more) engagement elements. Thus, an engagement between the filter element and the filter housing may be provided at least at two sides.

The filter element includes, for example, a filter medium (presently also “filter medium body”) and one or a plurality of stabilization elements, for example lateral bands and/or head bands (also referred to as end face bands) which stabilize the filter medium at least in sections in order to maintain its shape, for example in filter operation. The stabilization elements may for example form a closed or open frame—also monolithic—which surrounds the filter medium.

The stabilization elements may be connected to the filter medium by material fusion at the rim, for example may be glued. For this purpose, the stabilization elements may be heated and the filter medium may be pushed into the heated material. As an alternative, the stabilization elements may be injection molded onto the filter medium. Furthermore, an adhesive may be used as an auxiliary material. The stabilization elements may be produced of the same material as the filter medium. The stabilization elements may be manufactured, for example, of PET (polyethylene terephthalate), a glass fiber material, a synthetic fiber material or another plastic material or plastic material mixture or of a nonwoven. For example, the stabilization elements may be produced as injection molded plastic components. The stabilization elements may be stiff or flexible (for example also fluffy).

The lateral bands of the frame (which presently provide the “side face of the frame”) may include a grammage of, for example, about 100 to about 500 g/m5, for example about 200 to about 400 g/m5. The grammage is determined according to DIN EN 29073-1 (nonwoven). The tensile strength of the lateral bands or of the side faces of the frame may amount to, for example, at least about 100, for example at least about 200, even more at least about 500 N/50 mm in the machine direction (length direction). Transverse to the machine direction, the tensile strength may amount to at least about 20, for example at least about 100, and even more at least about 250 N/50 mm. The tensile strengths are determined according to DIN EN 29073-3.

A grammage and/or a tensile strength (in machine direction and/or transverse thereto) of the lateral bands amounts to a lesser value than that of the head bands, for example, the lateral bands are more elastic than the head bands. This means that, in comparison to the head bands, a smaller force is required for bending or lengthening the lateral bands by a predefined measure.

The filter medium may be configured folded or in a corrugated shape. As folds, for example, zigzag folds or W folds are known. The filter medium may be embossed and subsequently may be folded at embossed edges with formation of sharp fold edges. As a starting material, a flat material filter sheet may be provided which is correspondingly reshaped. For example, the filter medium is a filter fabric, a laid filter, or a filter nonwoven. For example, the filter medium may be manufactured by a spunbond method or meltblown method. Furthermore, the filter medium may be felted or needled. The filter medium may include natural fibers such as cotton or synthetic fibers, for example, of polyester, polyphenyl sulfide or polytetrafluoroethylene. The fibers may be oriented upon processing in, at a slant to and/or transverse to the machine direction.

The filter medium may be of a single layer or multiple layers. It may furthermore include an adsorption agent such as active carbon. Furthermore, the filter medium may include an antimicrobial action and/or anti-allergic action. As an anti-microbial substance, for example, zinc pyrithione or nanosilver, as an anti-allergic substance, for example, polyphenol is conceivable.

A corresponding filter element serves for filtering fluids, i.e., gaseous and/or liquid media, for example, air. The gaseous medium or air includes here also gas or air/solid mixtures and/or gas or air/liquid mixtures. For example, an air conditioning device may include the filter element.

An open filter medium may be designed to remove particles of the test dust A4 according to ISO-12103-1 from an air flow at a filtration rate of about 0.10 to about 0.30 m/s, in relation to the filter media surface area, at an air permeability of greater than about 3,000 l/m2s (determined according to ISO 9237 at 200 Pa). The determination of the filtration parameters may be realized according to DIN 71460-1, for example.

A highly separating filter medium may be designed to remove particles of the test dust A2 according to ISO 12103-1 as well as NaCl aerosol particles according to DIN 71460-1 from an air flow at a filtration rate of about 0.10 to about 0.30 m/s, in relation to the filter media surface area, at an air permeability of greater than about 600 l/m2s (determined according to ISO 9237 at 200 Pa). The determination of the filtration parameters may be realized according to DIN 71460-1, for example.

The filter element may include a seal which seals a raw side correlated with the filter element in relation to a clean side thereof. The seal may be configured as one and the same component with one or a plurality of stabilization elements of the filter element. As an alternative, the seal may be designed as an additional component. For example, the seal may be attached to the filter medium, to one or a plurality of stabilization elements, to the filter element, or to the filter housing.

The filter element may be exchangeably fixed in the filter housing. The engagement between the two engagement elements and the correlated engagement element counterparts may be releasable.

The filter element or a filter device with the filter element may be used in passenger cars, trucks, construction machines, watercraft, rail vehicles, aircraft, as well as in general in air conditioning technology, for example in heating/air conditioning devices, domestic appliances, fuel cells or in building technology. These motor vehicles or vehicles may be operated electrically and/or by means of fuel (for example gasoline or diesel). In respect to the building technology, for example stationary devices for treatment of air are conceivable.

According to an embodiment, the second one of the two engagement elements is connected by means of a second elastic element to the rigid element, wherein the second elastic element, upon transitioning of the two engagement elements between the locked state and the released state, generates a restoring force acting on the second one of the two engagement elements.

In this variant, at least two elastic elements are thus provided so that the two engagement elements each are movable in relation to the rigid element.

According to an embodiment, the second one of the two engagement elements is rigidly connected to the rigid element.

Accordingly, only the first engagement element is movable in relation to the rigid element while the second engagement element is coupled rigidly (i.e., immobile) to the latter. The rigid connection between the second engagement element and this rigid element may be embodied directly or indirectly. Presently, “directly” is understood as “without mechanical interposition of further elements or components”.

According to an embodiment, the first elastic element and/or the second elastic element is designed to produce the restoring force due to a bending-elastic deformation thereof.

As an alternative, the elastic element may be configured as a tension/compression-deformable element. For example, the elastic element is configured as a leaf spring, spiral spring, flat spring or corrugated spring.

According to an embodiment, the rigid element is a bending-resistant element.

As an alternative, the bending-resistant element may be a tension-resistant/compression-resistant element. For example, such an element includes carbon fibers or aramid fibers.

According to an embodiment, the rigid element includes a greater tension/compression resistance or bending stiffness than the first and/or the second elastic element and/or than the frame in the region of the side face.

In this way, it is ensured that it is substantially the first and/or the second elastic element which provides the deformation for converting between the locked state and the released state.

According to an embodiment, the rigid element is a one-piece component of the frame and/or is embodied as a lateral band of the frame.

In this way, a simple configuration results that is efficiently producible.

According to an embodiment, the rigid element is a separate part which is attached to the side face of the frame, for example welded or glued thereto.

This variant may have advantages in regard to material technology in comparison to a one-piece manufacture.

According to an embodiment, the restoring force which is acting on the first one of the two engagement elements and the restoring force which is acting on the second one of the two engagement elements are oriented toward each other or opposite to each other.

In this way, locking or latching of the engagement elements and engagement element counterparts may be achieved in a simple manner. For example, the two restoring forces may be coaxially aligned.

According to an embodiment, the two engagement elements are embodied mirror-symmetrically relative to each other, wherein a corresponding symmetry axis is oriented in a flow direction.

In embodiments, the filter element may be installed in different orientations in the housing in this way.

According to an embodiment, the first and/or the second elastic element is fastened to the rigid element and/or the frame, for example glued or welded, or is formed as one piece, for example by injection molding of plastic material, together with the rigid element and/or the frame.

Fastening of the first and/or the second elastic element at the rigid element and/or at the frame may be realized indirectly or directly. For example, the first and/or the second engagement element may also be attached, for example glued or welded, to the first and/or the second elastic element, or may be formed as one piece, for example by injection molding of plastic material, together with the first or the second elastic element (optionally including the rigid element and/or the frame). Furthermore, the second engagement element (in the variant in which it is rigidly fastened to the rigid element) may be fastened to the rigid element and/or to the frame, for example glued or welded, or may be formed as one piece, for example by injection molding of plastic material, together with the rigid element and/or the frame.

According to an embodiment, the first and/or the second elastic element is fastened by means of a socket to the frame and/or to the rigid element, wherein the first and/or the second elastic element is oriented along the flow direction or at an acute angle thereto, wherein for example at an end, facing away from the socket, of the first and/or the second elastic element the first one and/or the second one of the two engagement elements is provided, wherein for example the elastic element extends parallel to and spaced apart from the at least one side face of the frame and/or the rigid element.

The elastic element in this case may be embodied, for example, as a bending-elastic arm. Such an arrangement may be produced in a simple manner, for example, by injection molding of plastic material.

According to an embodiment, the first and/or the second elastic element is rod-shaped and/or the first one and/or the second one of the two engagement elements is of a cam shape.

In this way, geometries that may be easily manufactured are provided.

According to an embodiment, the first and/or the second elastic element is configured in a meander shape and/or the first one and/or the second one of the two engagement elements is of a triangular shape.

The meander-shaped design provides long spring travel. The triangular shape provides a beneficial latch geometry.

According to an embodiment, the rigid element is designed as a flat part. The meander-shaped elastic element extends in, or exclusively in, the plane of the flat part. The meander-shaped elastic element may be arranged in a window in the flat part, wherein for example the window may be closed by means of a cover plate.

In this way, the elastic element may be accommodated in a space-saving and optionally also well protected manner.

According to an embodiment, the side face is oriented perpendicularly to the flow direction and/or a lateral band of the frame includes the side face.

The side face is positioned for example opposite the filter housing or a wall thereof with the engagement element counterparts.

According to a further embodiment, the frame includes at least two oppositely positioned side faces, wherein engagement elements are arranged at the at least two side faces, respectively, and extend away from the filter medium body and may be brought into engagement with respective correlated engagement element counterparts at the filter housing for attachment of the filter element at or in it, wherein for example the engagement elements are configured mirror-symmetrically relative to each other in relation to a symmetry axis which is positioned in the main extension plane of the filter medium body.

By means of the engagement elements at both sides, the filter element may be held particularly securely.

According to a further aspect, a filter device, for example an interior filter device, for example, for a motor vehicle, is provided. The filter device includes a filter element as described above, and a filter housing at or in which the filter element is fastened, wherein the two engagement elements are in engagement with the correlated engagement element counterparts.

According to an embodiment, an engagement element counterpart correlated with the first and/or the second one of the two engagement elements includes an insertion section and a locking section, wherein the first one and/or the second one of the two engagement elements is configured to be guided upon attachment of the filter element at or in the filter housing through the insertion section of the correlated engagement element counterpart and guided toward the locking section of the correlated engagement element counterpart, wherein the restoring force secures the first one and/or the second one of the two engagement elements in the locking section against disengagement therefrom, wherein for example the insertion section is designed to counteract the restoring force in order to change the distance between the two engagement elements.

In this way, a simple fastening possibility of the filter element at the filter housing is provided. The insertion section may end at a rim of the side face which corresponds, for example, to the raw side or clean side of the filter element. The locking section may extend, for example, parallel to the rim of the side face.

According to an embodiment, the insertion section is oriented in flow direction or at an acute angle thereto. The locking section may be connected to the insertion section and/or may be angled relative thereto. The locking section and/or the insertion section may be designed as a groove.

The locking section and the insertion section may be connected to each other so that they form a continuous groove. An angle between the locking section and the insertion section may amount to, for example, between about 30° and about 90°, for example between about 70° and about 90°, further for example about 90°.

According to an embodiment, the correlated engagement element counterparts each include a locking section, wherein the locking sections face away from each other or face each other and/or are mirror-symmetrical in relation to a symmetry axis in a flow direction.

When the locking sections face away from each other, the first distance between the two engagement elements is smaller than the second distance. In other words, the engagement elements are moved away from each other in order to produce the locked state or moved toward each other to produce the released state.

When the locking sections, on the other hand, are oriented toward each other, the first distance between the two engagement elements is larger than the second distance. In other words, the engagement elements are moved toward each other in order to produce the locked state.

The two insertion sections correlated with the two locking sections are arranged parallel to each other.

According to an embodiment, the insertion section includes a section acting as an incline on the first and/or the second one of the two engagement elements, wherein the locking section forms an undercut at an end of the incline.

By means of the incline, the first and/or the second engagement element may be transferred simply into the locked state because the incline converts an axially oriented insertion movement of the filter element into a movement that changes the distance of the engagement elements.

According to an embodiment, the incline is oriented at a slant to the flow direction and/or the undercut extends transversely to the flow direction.

In this way, a simple mounting of the filter element in the filter housing results.

According to an embodiment, one or all correlated engagement element counterparts include a V-shaped geometry forming the insertion section, which at its pointed end widens with formation of two undercuts, wherein one of the undercuts forms the locking section.

In this variant, filter elements with engagement elements oriented in different directions may be used. This means that the corresponding filter housing may be used more flexibly.

In embodiments, it may be provided that the filter element is held independent of contact surfaces at the filter housing (aside from the engagement element counterparts)—in other words is “freely suspended”—in the installation space or in the filter device.

Furthermore, the filter device may be configured as a multi-stage filter system in which further filter elements are positioned at the afore described filter element and are indirectly held by it. For example, it may be provided that the filter element according to the invention is sealed indirectly through a further filter element, wherein for example an axially oriented seal pretension force is generated by the interaction of the filter element according to the invention with a filter housing and is transmitted to the further filter element by contact with the further filter element. The further filter element includes in this context a housing interface while the filter element according to the invention is sealed only indirectly, i.e., through the further filter element, in relation to the housing. A contact between the filter element according to the invention and the further filter element may be realized with interposition of a seal but also without a seal.

According to a further aspect, a vehicle with a filter device as described above is proposed.

According to yet another aspect, a use of a filter element, as described above, in a filter device, as described above, is provided, wherein the two engagement elements are brought into engagement with the correlated engagement element counterparts.

According to yet another aspect, a method for attachment of a filter element at or in a filter housing is provided. In this context, the filter element includes a filter body and an at least partially circumferentially extending frame. The method includes the steps:
a) inserting the filter element into the filter housing, and
b) bringing into engagement two engagement elements of the filter element, provided at a side face of the frame of the filter element and connected in a force-conducting manner to each other by means of a rigid element at the side face, with correlated engagement element counterparts of the filter housing with change of a distance between the two engagement elements, wherein an elastic element connecting a first one of the two engagement elements to the rigid element produces a restoring force on the first one of the engagement elements upon change of the distance.

According to an embodiment, the first one and/or the second one of the engagement elements is inserted along an (as needed, a respective) insertion section of the filter housing substantially along the flow direction prior to step b).

The features and advantages described in connection with the first aspect apply correspondingly to the further afore described aspects and vice versa.

Numbers, such as “one” or “two” are presently not to be understood as being limited to precisely “one” or precisely “two”. Instead, also more than “one” or “two” of the corresponding elements, for example, of the engagement elements, may be provided as presently nothing to the contrary is indicated.

Further possible implementations of the invention include also combinations of features or method steps described above or in the following in relation to the embodiments and not explicitly mentioned. In this context, a person of skill in the art will also add individual aspects as improvements or supplements to the respective basic form of the invention.

Further embodiments of the invention are subject matter of the embodiments of the invention described in the following detailed description, in which the invention is explained in more detail with the aid of exemplary embodiments with reference to the attached Figures.

### BRIEF DESCRIPTION OF DRAWINGS

FIG. 1 shows a schematic illustration of a motor vehicle with a filter device according to the invention.

FIG. 2 is a perspective illustration of the filter device of FIG. 1, comprising a filter housing with an interior filter arranged therein according to the invention.

FIG. 3 is a perspective illustration of the interior filter of FIG. 2 comprising a frame and a filter medium.

FIG. 4 shows in a perspective illustration the filter medium of FIG. 3.

FIGS. 5A to 5H show different views of an embodiment of the invention in which pivotable engagement elements are provided.

FIG. 6 shows a variant of the filter housing.

FIGS. 7A to 7F shows different views of an embodiment of the invention in which linearly movable engagement elements are provided.

FIGS. 8A and 8B show embodiments of a frame with engagement elements.

FIGS. 9A to 9F show different configurations when using engagement elements which are moved away from each other to produce the locked state.

FIGS. 10A to 10E shows the configurations of FIG. 9A to 9F but with the difference that the engagement elements are moved toward each other to produce the locked state.

FIG. 11 is a flowchart of a method according to an embodiment of the invention.

FIG. 12 is a longitudinal section of an embodiment of a multi-stage filter system according to the invention.

In the Figures, same or functionally the same elements, as nothing to the contrary is indicated, are provided with the same reference characters.

### DETAILED DESCRIPTION

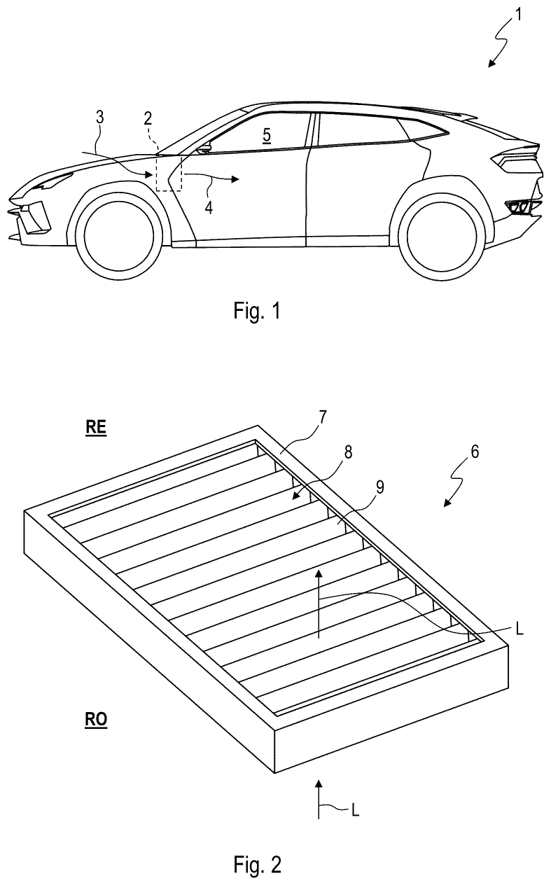

FIG. 1 shows a motor vehicle 1 with an air conditioning device 2 which may also be configured as a heating and air conditioning device. The air conditioning device takes in ambient air 3 and guides filtered air 4 to a cabin 5 of the motor vehicle 1. For this purpose, the air conditioning device 2 comprises a filter device 6 illustrated in FIG. 2.

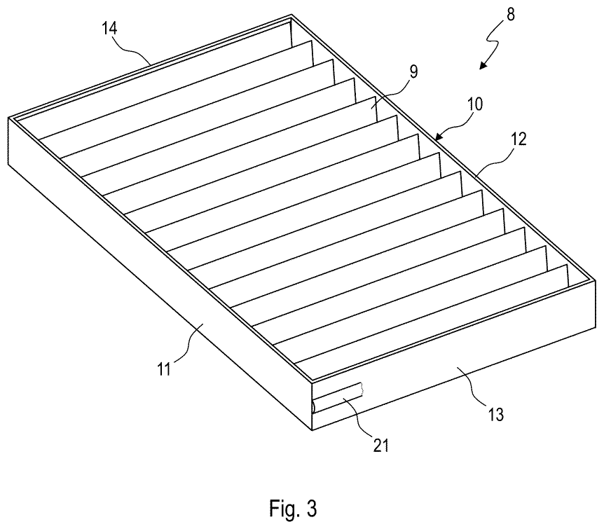

The filter device 6 comprises a filter housing 7 with an interior filter 8 (presently also “filter element”) arranged for example exchangeably therein. The interior filter 8 is illustrated in more detail in FIG. 3. The interior filter 8 comprises a filter medium 9 (presently also “filter medium body”) to which is connected a frame 10 (FIG. 3), for example all around it. The frame 10 may comprise, for example, lateral bands 11, 12 and head bands 13, 14.

The filter medium 9 is illustrated in FIG. 4 in isolation. The filter medium 9 is, for example, a filter nonwoven, filter fabric, laid filter or filter felt, for example a needled felt. For example, the filter medium 9 may be produced by a meltblown method. The filter medium 9 may comprise natural fibers, such as cotton, or synthetic fibers, for example, of polyester, polyphenyl sulfide or polytetrafluoroethylene. The fibers may be oriented during processing in, at a slant to and/or transverse to the machine direction M. Also, the fibers may be stretched in a spatial direction. The filter medium 9 may be designed as a single layer or multi-layered.

The filter medium 9 may comprise folds 15 which typically extend transverse to the machine direction M. The folded filter medium 9 is also referred to as pleats. The folds 15 may be produced by means of folding along sharp fold edges 16 (also referred to as “fold tips”) or by a corrugated configuration of the filter medium 9. A respective fold 15 may be defined by two fold sections 15a which are connected to each other by a corresponding fold edge 16. According to the embodiment, the fold edges 16 are oriented in or opposite to the inflow direction or flow direction which is indicated in FIG. 2 by the arrow L. The folding may be carried out for example by zigzag folding.

Also, a folding in which the folds 15 have a variable height H is possible. Furthermore, the fold distance between the folds 15 may vary so that the distance A1 differs from the distance A2. The filter medium 9 may be designed to be self-supporting, i.e., the folds 15 are shape-stable in case of a flow as intended in filter operation.

The filter medium 9 is delimited in machine direction M by end folds 17, 18. Transversely thereto, the filter medium 9 is delimited by fold end face edges 19, 20 (also referred to as fold profiles). The term “fold end face edge” means the end face fold surface which extends between neighboring fold edges 16 of a respective fold 15.

The filter medium 9 in a plan view, i.e., in the plane E of its flat extension, may have a rectangular shape. However, also a triangular, pentagonal or polygonal, round or oval shape is conceivable.

The lateral bands 11, 12 illustrated in FIG. 3 are connected to the fold end face edges 19, 20, the head bands 13, 14 to the end folds 17, 18, for example by fusing, welding or gluing. The lateral bands 11, 12 as well as the head bands 13, 14 may form the frame 10 as a one-piece or multi-part configuration. The lateral bands 11, 12 as well as the head bands 13, 14 may be produced, for example, of a flexible fiber material or for example as rigid injection molded plastic components, for example, the frame 10 may be produced by injection molding onto the filter medium 9.

The filter medium 9 may function as particle filter and filter in this context particles, for example dust, aerosols or liquid droplets from the intake air 3. In addition, the filter medium 9 may function as an odor filter. For this purpose, it may comprise, for example, a layer of active carbon. The filter medium 9 may be generally configured to absorb or adsorb certain solid, liquid and/or gaseous substances.

In filter operation, the filter medium 9, as illustrated in FIG. 2, is flowed through perpendicularly to its flat extension by air L. The air L flows in this context from a raw side RO of the interior filter 8 to a clean side RE.

In order to ensure a sufficient sealing action between the raw side RO and the clean side RE, a seal may be provided between the interior filter 8 and the filter housing 7. The seal may be integrated, for example, in the frame 10. In this case, the frame 10 is at least partially formed of a sealing material. As an alternative, the seal may be provided as an additional part, for example, fastened to the frame 10, for example injection molded thereto. Such a seal 21 is illustrated as an example and as a detail in FIG. 3.

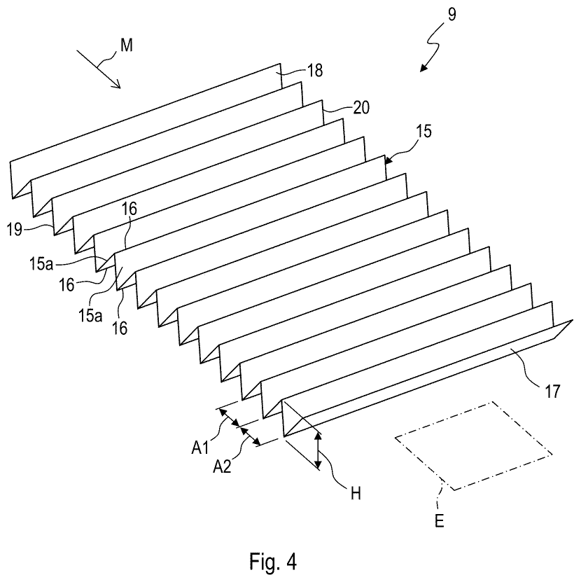

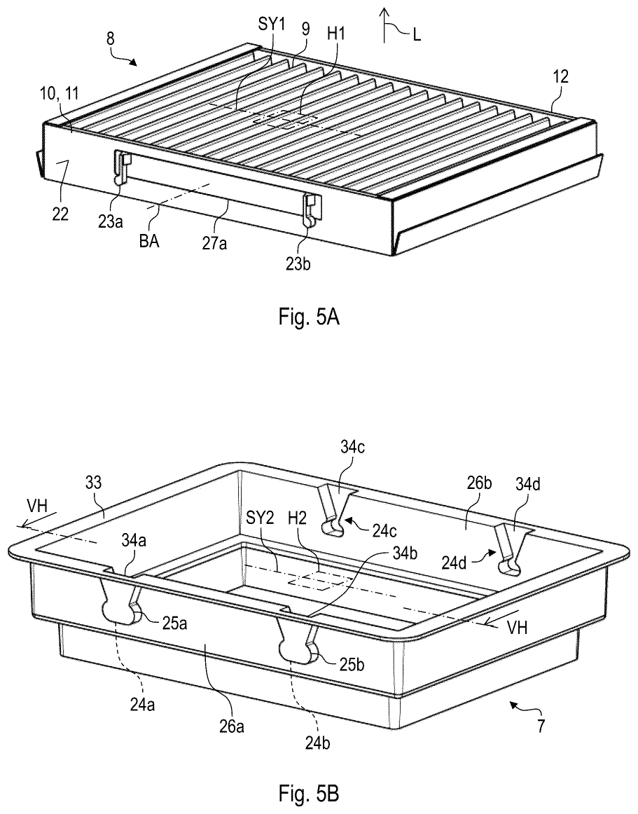

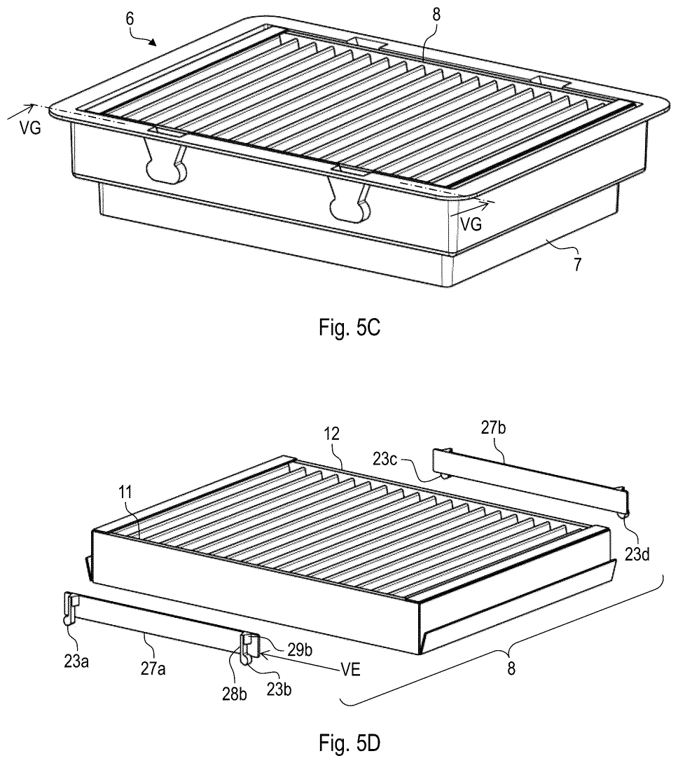

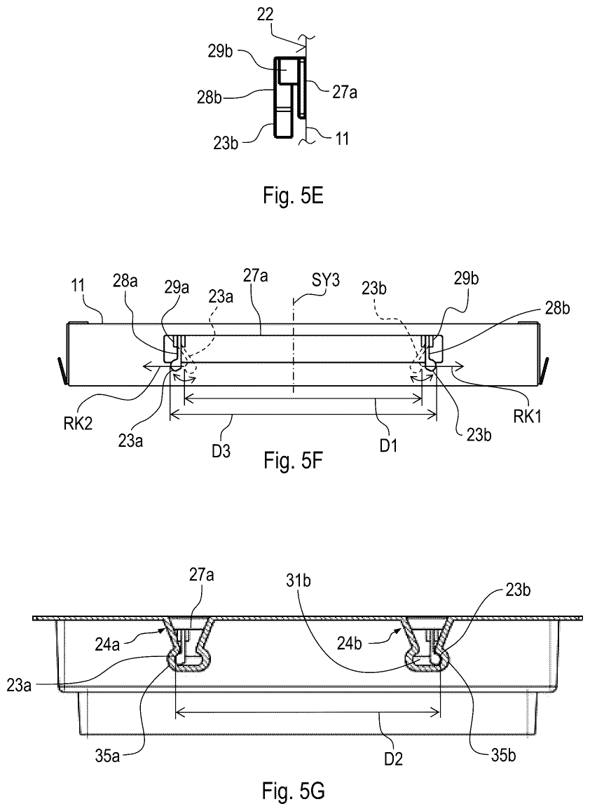

The features described in connection with FIGS. 1 through 4 apply likewise to the embodiments according to FIGS. 5A to 5H explained in the following.

FIGS. 5A to 5H show a first embodiment. First, in reference to FIGS. 5A and 5B, they show perspectively and separate from each other, i.e., in the not yet mounted state, a filter element 8 and a filter housing 7. They may be assembled to a filter device 6 illustrated in perspective view in FIG. 5C, wherein the filter element 8 is detachably connected to the filter housing 7.

In FIG. 5A, a lateral band 11 of the frame 10—here, for example, closed—is shown with a side face 22. The side face 22 faces in a direction perpendicular to the flow direction L. Two engagement elements 23a, 23b project away from the side face 22. This means that, in a plan view of the filter element 8, the engagement elements 23a, 23b project outwardly away from the filter medium 9.

Two further engagement elements (not visible in FIG. 5A to 5C because hidden) are arranged at the side face of the oppositely positioned lateral band 12. It is possible that more than two engagement elements are provided at one or at both lateral bands 11, 12.

The engagement elements 23a, 23b each may be brought into engagement with an engagement element counterpart 24a, 24b (FIG. 5B) of the filter housing 7. This corresponds then to the mounted state of the filter device 6, as illustrated in FIG. 5C. The reference character lines of the reference characters 24a, 24b are illustrated in dashed lines because they lead respectively to the outer side of a protrusion 25a, 25b (or projection) forming an engagement element counterpart 24a, 24b at its inner side. The protrusions 25a, 25b are formed at a wall 26a of the filter housing 7. In place of the protrusions 25a, 25b, it may be provided that the engagement element counterparts 24a, 24b are formed in the wall thickness of the wall 26a.

On the other hand, clearly shown are the engagement element counterparts 24c, 24d which are provided positioned opposite to the engagement element counterparts 24a, 24b at the wall 26b of the filter housing 7. The walls 26a, 26b may be part of a closed frame of the filter housing 7 which—in the mounted state—surrounds completely the filter element 8 at its circumference and lies in its main extension plane H1.

The engagement elements 23a, 23b may be embodied symmetrically in relation to the engagement elements not illustrated in FIG. 5A to 5C, for example in relation to a symmetry axis SY1 which is arranged centrally between and parallel to the lateral bands 11, 12 and which extends also in the main extension plane H1 of the filter element 8. As an alternative or in addition, the engagement element counterparts 24a, 24b may also be embodied mirror-symmetrically to the engagement element counterparts 24c, 24d about an axis SY2. The axis SY2 is positioned centrally between and parallel to the walls 26a, 26b and moreover in the main extension plane H2 of the filter housing 7. However, also non-symmetrical embodiments are conceivable.

For example, the filter housing 7 may comprise only the wall 26a in embodiments. In this case, the filter element 8 may only be fastened at one side of the filter housing 7 by means of the engagement elements 23a, 23b as well as the engagement element counterparts 24a, 24b.

FIG. 5D shows an exploded view of the filter element 8 of FIG. 5A. The filter element 8 comprises rigid elements 27a, 27b which here are embodied as separate parts and may be manufactured, for example, of a plastic material. According to the embodiment, the rigid elements 27a, 27b are embodied as elongate or rectangular flat parts. The rigid element 27a is fastened to the lateral band 11, the rigid element 27b to the lateral band 12, for example, welded or glued thereto. For example, the rigid elements 27a, 27b extend parallel to the respective lateral band 11 or 12, respectively.

The rigid element 27a carries the engagement elements 23a, 23b, the rigid element 27b the oppositely positioned engagement elements 23c, 23d which now are partially visible here. As will be explained by means of the engagement element 23b representative for the other engagement elements, it comprises, for example, a cam shape wherein however also other contours are conceivable. The engagement element 23b is fastened at an end—at the bottom in FIG. 5D—of an elastic element 28b. At its other end—at the top in FIG. 5D—the elastic element 28b is connected to a socket 29b. The socket 29b, in turn, is fastened to the rigid element 27a. For example, the elastic element 28b is embodied in the form of a flat spring. The engagement element 23b, the elastic element 28b, the socket 29b, and optionally the rigid element 27a may be produced as a one-piece component, for example of plastic material and, as needed, manufactured by injection molding.

FIG. 5E shows a view VE of FIG. 5D and shows that the elastic element 28b extends parallel and spaced apart from the side face 22 (which has been added here compared to FIG. 5D). For example, the elastic element 28b may extend parallel or at an acute angle in relation to the flow direction L.

As illustrated with the aid of FIG. 5F showing a side view of FIG. 5A, the elastic element 28b enables pivoting of the engagement element 23b about the socket 29b, as illustrated by the double arrow, wherein the force-free initial position (may correspond to the locked state) of the engagement element 23b is illustrated by solid line and the disengaged pivot position (corresponds to the released state) of the engagement element 23b is illustrated in dashed line. Upon pivoting into the disengaged pivot position, the elastic element 28b is elastically deformed and generates thereby a restoring force RK1.

The same applies to the engagement element 23a, also shown in FIG. 5F, which is connected to a socket 29a by means of an elastic element 28a. The engagement element 23a is pivotable opposite to the engagement element 23b. Upon pivoting into the disengaged pivot position indicated in dashed line, the engagement element 23a produces a restoring force RK2 which is directed opposite to the restoring force RK1. According to the embodiment, the engagement elements 23a, 23b or the corresponding cams face away from each other and are configured mirror-symmetrically relative to each other in relation to an axis SY3. The axis SY3 extends parallel to the flow direction L and divides the lateral band 11 into two halves of the same size.

The restoring forces RK1 and RK2 effect a force flow extending from the engagement element 23b through the elastic element 28b, through the socket 29b, through the rigid element 27a into the socket 29a, into the elastic element 28a, and into the engagement element 23a. The corresponding bending moment effected by the restoring forces RK1, RK2 is absorbed completely in the rigid element 27a, for which reason the latter is a bending-resistant element according to the embodiment. Correspondingly, the lateral band 11, upon mounting of the filter element 8 in the housing 7, does not bend or bends only insignificantly. For example, the rigid element 27a for this purpose comprises a greater bending resistance (in other variants additionally or alternatively a greater tensile stiffness/compressive strength) than the respective elastic element 28a, 28b and also than the lateral band 11. The bending resistance means here the bending resistance about an axis BA (FIG. 5A) perpendicular to the side face 22. For example, by suitable material selection, an E module of the rigid element 27a may be greater than an E module of the respective elastic element 28a, 28b and also than an E module of the lateral band 11.

The disengaged pivot position of the engagement elements 23a, 23b illustrated by dashed line corresponds presently to a released state. In the latter, the engagement elements 23a, 23b comprise a first distance D1 relative to each other. FIG. 5G shows a section VG of FIG. 5C. FIG. 5G illustrates the locked state in which the engagement elements 23a, 23b are in engagement with the respective correlated engagement element counterparts 24a, 24b. In the locked state, the engagement elements 23a, 23b have a second distance D2 relative to each other. The distance D2 may be smaller or of the same size as the distance D3 illustrated in FIG. 5F. The engagement elements 23a, 23b have the distance D3 in an undeformed (force-free) state of the elastic elements 28a, 28b. The undeformed state corresponds to the unmounted state of the filter housing 7 and of the filter element 8, i.e., when they are present as separate parts. When the distance D2 is smaller than the distance D3, this means that the engagement elements 23a, 23b in the locked state are resting with a pretension at the engagement element counterparts 24a, 24b.

FIG. 5H shows a section VH of FIG. 5B. In the following, with the aid of FIGS. 5G and 5H the configuration of the engagement element counterparts 24a, 24b will be explained in more detail. They each comprise—as will be explained with the aid of the engagement element counterpart 24b representative of all engagement element counterparts of the present embodiment—an insertion section 30b and a locking section 31b which are formed in the protrusion 25b (FIG. 5B) as a continuous groove. The insertion section 30b, as shown in FIG. 5B, is open toward a rim 33 of the frame 10 (in FIG. 5B at the top). A corresponding opening is identified at 34b. The insertion section 30b forms an incline 32b (FIG. 5H) which is slanted, for example, at an angle of about 5° to about 45° in relation to the flow direction L.

When mounting the filter element 8 in the filter housing 7, the former—in FIGS. 5A and 5B from above—is inserted into the latter. For this purpose, the engagement elements 23a to 23d are inserted into the respective correlated opening 34a to 34d. The incline 32b has the effect that the engagement element 23b is pivoted from its initial position into its disengaged pivot position and finally, at the end of the incline 32b, snaps outwardly into an undercut 35b (FIG. 5H) of the locking section 31b, as illustrated in FIG. 5G. In opposite direction thereto, the engagement element 23a moves along the incline 32a which is arranged mirror-symmetrically about a symmetry axis SY4 in relation to the incline 32b. The symmetry axis SY4 is arranged parallel to the flow direction L and divides the wall 26a into two halves of the same size. At the end of the movement, the engagement element 23a snaps outwardly into the undercut 35a. Here, “outwardly” means that the engagement elements 23a, 23b for locking at the respective undercut 35a, 35b move away from each other. The distance between the engagement elements 23a, 23b changes thus from initially D3, then to D1, and finally to D2 (wherein it is possible that D2=D3).

When all of the engagement elements 23a to 23d are arranged in the respective correlated locking sections 31a, 31b (the further locking sections are here without reference characters) and are locked thereat, all six degrees of freedom of the filter element 8 are blocked. For releasing the connection, the engagement elements 23a to 23d, or at least one thereof at each side (corresponding to the lateral bands 11, 12), are pivoted into the respective disengaged pivot position, e.g., by hand.

In the variant illustrated for example in FIG. 5H, the insertion section 30b and the locking section 31b themselves are symmetrically designed. This means that the incline 32b has positioned opposite thereto a further incline 36b so that the inclines 32b, 36b supplement each other to a V-shaped geometry. A further undercut 37b is positioned opposite the undercut 35b so that the V-shaped geometry at its pointed end widens again at both sides. This variant is advantageous in so far that also filter elements 8 may thus be inserted into the filter housing 7 in which the engagement elements 23a, 23b, in order to reach the disengaged pivot position, are pivoted away from each other, i.e., the distance D1 is greater than the distance D2 or D3.

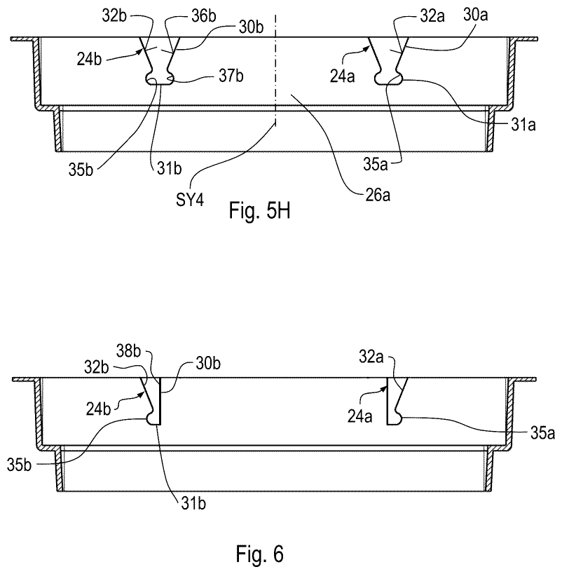

On the other hand, FIG. 6 shows in a view which corresponds to the view of FIG. 5H, an embodiment in which the insertion section 30b and the locking section 31b are not symmetrically embodied. At the inner side (“inner” means here the region between the two engagement element counterparts 24a, 24b), the insertion section 30b and the locking section 31b each are delimited by a straight wall 38b, wherein however the latter is not required and may be designed differently.

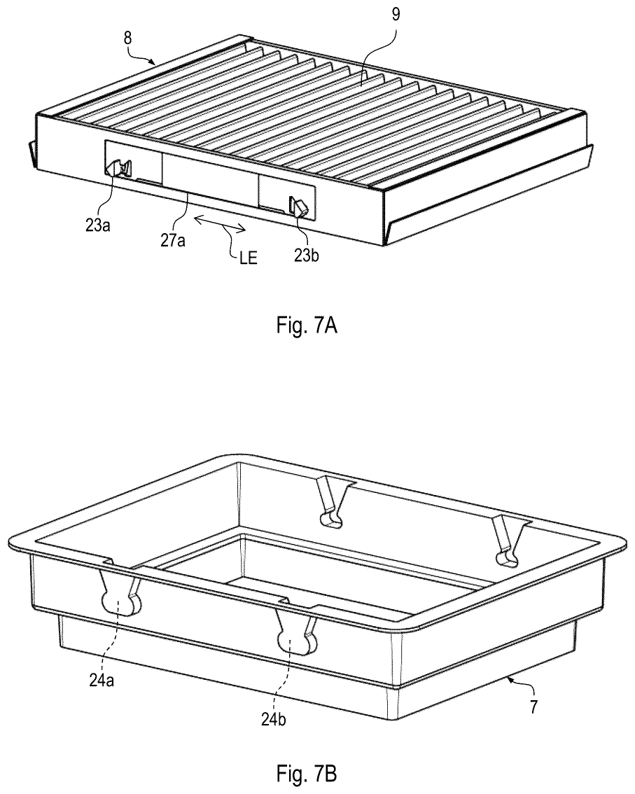

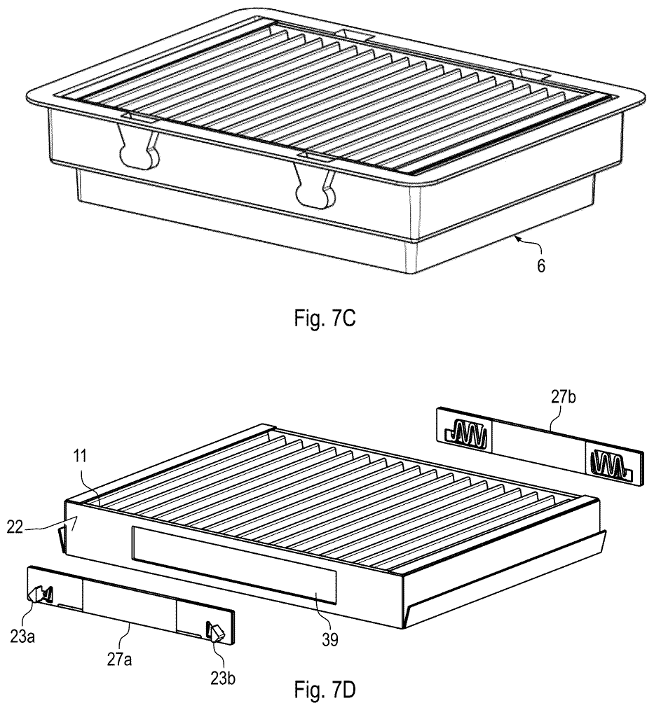

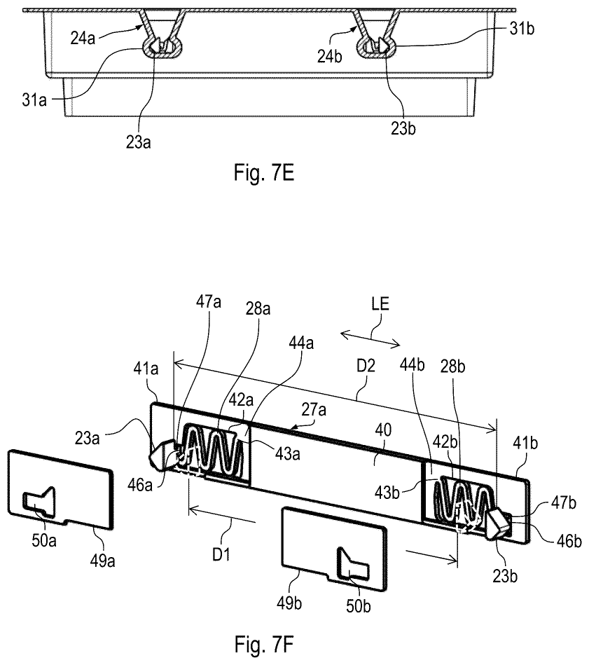

FIGS. 7A to 7F show a further embodiment. The filter housing 7 corresponds here, for example, to that of FIG. 5B or FIG. 6. Differences result in respect to the engagement elements 23a, 23b and their connection to the rigid element 27a. Here, the views of FIGS. 7A to 7D correspond to those of FIGS. 5A to 5D. FIG. 7E corresponds to the view of FIG. 5G. FIG. 7F shows an exploded view of the rigid element 27a.

The engagement elements 23a, 23b are here provided to be movable exclusively linearly and for example parallel to the length extension LE (FIG. 7A) of the lateral band 11 to adjust them between the released state (distance D1 in FIG. 7F) and the locked state (distance D2 in FIG. 7F as well as FIG. 7E).

In detail, it may be provided that the rigid element 27a is arranged in a pocket 39 in the lateral band 11 illustrated in FIG. 7D. As an alternative, the rigid element 27a may also be glued onto the lateral band 11.

The rigid element 27a is configured, for example, as a rectangular flat part and, as illustrated in FIG. 7F, comprises a rigid section 40 adjoined in longitudinal direction LE by two frames 41a, 41b. Each frame 41a, 41d defines at the inner side a window 42a, 42b. The elastic elements 28a, 28b are embodied in this embodiment in a meander shape and are supported at their first end 43a, 43b at a frame element 44a, 44b of the respective window 42a, 42b, wherein the respective frame element 44a, 44b faces the rigid section 40. At its second end, the respective elastic element 28a, 28b carries the engagement element 23a, 23b. The meander-shaped configuration extends in a space-saving manner exclusively in the plane of the respective window 42a, 42b or in the plane of the rigid element 27a and permits the purely linear mobility of the respective engagement element 23a, 23b. The respective engagement element 23a, 23b comprises a guide section 46a, 46b which is guided in linearly slidable manner in a guide counter section 47a, 47b in the respective window 42a, 42b. Facing away from the guide section 46a, 46b, the respective engagement element 23a, 23b comprises a contour, for example, a triangular one, which is designed for engagement in a corresponding locking section 31a, 31b (FIG. 7E) of the filter housing 7. The respective window 42a, 42b may be covered or is covered by means of a cover plate 49a, 49b. This has for example the purpose that the meander-shaped elastic elements 28a, 28b is accommodated in a protected way. The cover plates 49a, 49b are embodied with an opening 50a, 50b, respectively, which enables passage of the engagement elements 23a, 23b when the cover plate 49a, 49b is mounted at the rigid element 27a.

The rigid section 40, the frames 41a, 41b, the elastic elements 28a, 28b, and the engagement elements 23a, 23b may be manufactured as a one-piece plastic component, for example by injection molding.

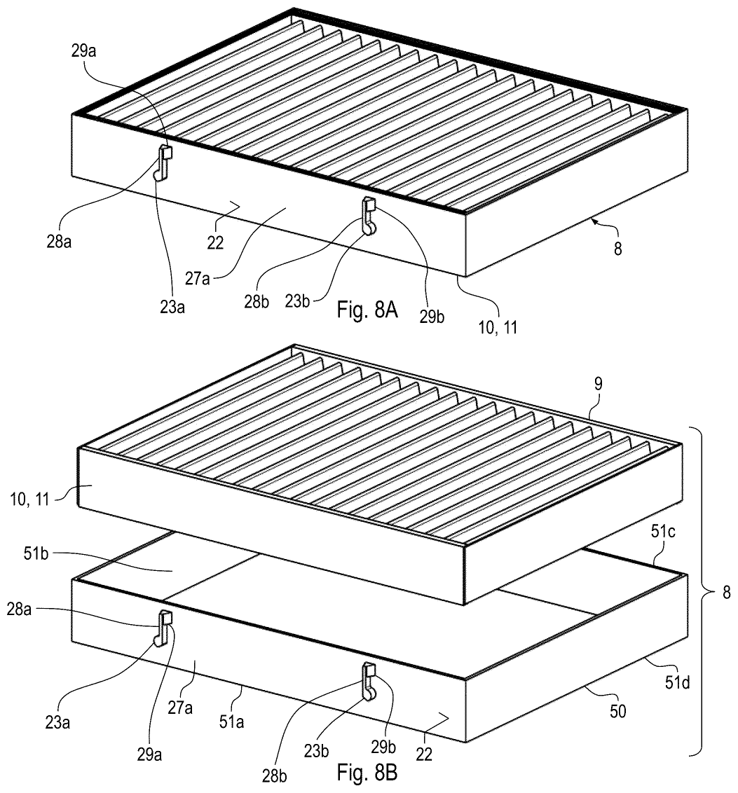

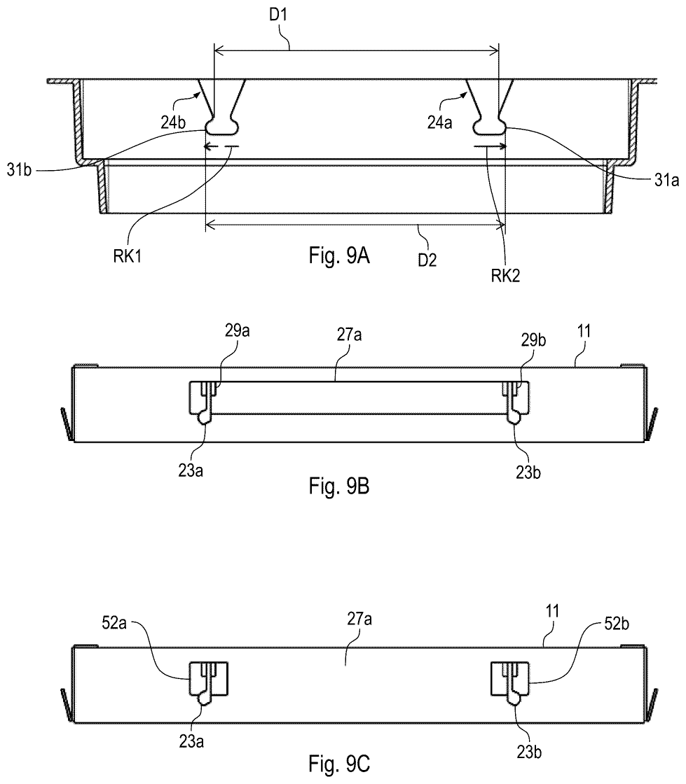

FIG. 8A illustrates an embodiment in which the rigid, for example bending-resistant, element 27a is a component of the lateral band 11, i.e., is integrated therein. For this purpose, the lateral band 11—in any case, in the section which extends between the sockets 29a, 29b correlated with the engagement elements 23a, 23b—may be manufactured of a rigid plastic material. As an alternative or in addition, fibers, for example, carbon fibers and/or aramid fibers, may be integrated into the material of the lateral band 11 to increase its stiffness. In this variant, the frame 10 with the lateral band 11 (including rigid element 27a, sockets 29a, 29b, elastic elements 28a, 28b, and engagement elements 23a, 23b) is injection molded to the filter medium 9.

As an alternative, an additional frame 50 may be provided, as illustrated in FIG. 8B. It comprises, for example, four frame elements 51a to 51d. The frame element 51a forms the rigid element 27a. For example, the engagement elements 23a, 23b are attached at its side face 22. The filter medium 9 together with its frame 10 is then connected to the additional frame 50. For example, the additional frame 50 may be manufactured prior to this as a separate (for example, plastic) part, for example injection molded. Alternatively, the frame 50 is directly injection molded onto the frame 10.

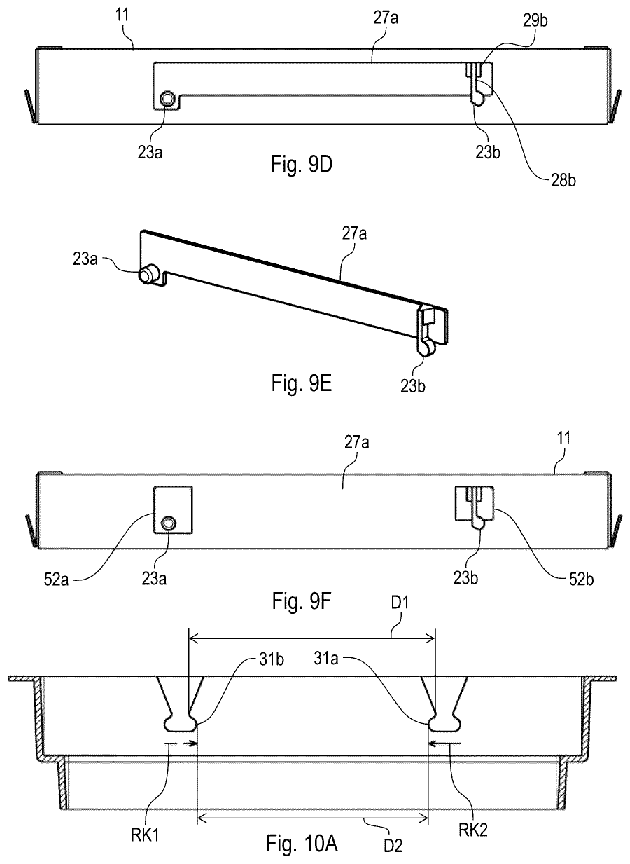

FIGS. 9A to 9F illustrate different embodiments and embrace in this context already described embodiments. The embodiments have in common, as illustrated with the aid of FIG. 9A, that the locking action with the locking sections 31a, 31b is realized in that the distance between the engagement elements 23a, 23b upon transitioning from the released state into the locked state is enlarged, i.e., the second distance D2 (locked state) is greater than the first distance D1 (released state).

According to FIG. 9B, the engagement elements 23a, 23b each are provided in a pivotable manner and coupled by means of a rigid element 27a, which is formed as an additional component, to the respective correlated sockets 29a, 29b.

In contrast to FIG. 9B, in the embodiment according to FIG. 9C it is provided that the sockets 29a, 29b each are connected by means of a plate 52a, 52b to the lateral band 11, wherein the lateral band 11 comprises the rigid element in an integrated manner.

In the embodiment according to FIG. 9D, in contrast to that according to FIG. 9B, the engagement element 23a is rigid and connected directly to the rigid element 27a, for example, is manufactured together with it as one piece. This means that the engagement element 23a is not movable in relation to the rigid element 27a or the lateral band 11. The relative mobility to the engagement element 23b results from its pivotability due to its attachment at the socket 29b by means of the elastic element 28b. The rigid element 27a together with the engagement elements 23a, 23b is illustrated perspectively in FIG. 9E. There it is shown that the engagement element 23a is designed as a peg which at one end is free and at its other end is connected to the rigid element 27a.

FIG. 9F illustrates a variant in relation to FIG. 9D in which the engagement elements 23a, 23b each are connected by means of a plate 52a, 52b to the lateral band 11, wherein the lateral band 11 comprises or forms the rigid element 27a in an integrated manner.

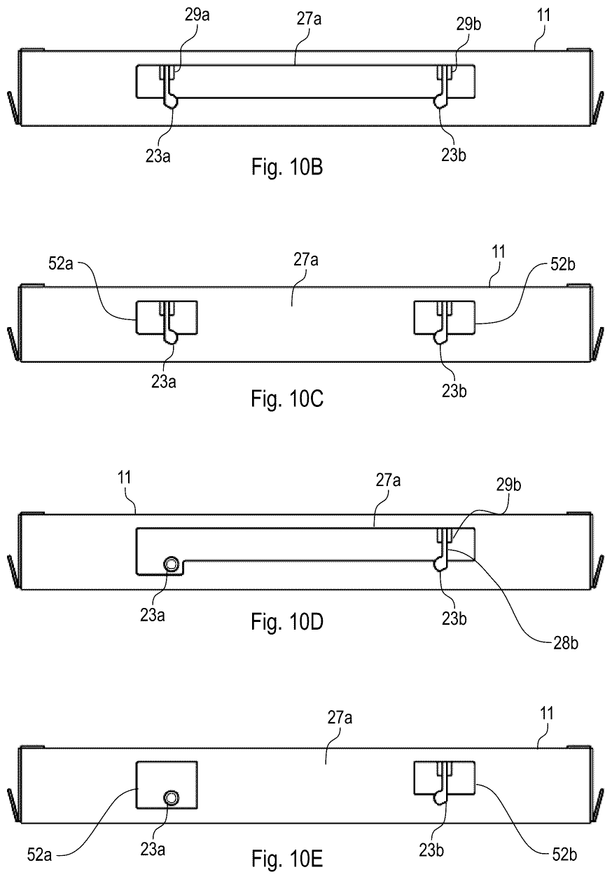

FIGS. 10A to 10E correspond to FIGS. 9A to 9D and 9F with the difference that the distance between the engagement elements 23a, 23b upon transitioning from the released state into the locked state is reduced, i.e., the second distance D2 (locked state) is smaller than the first distance D1 (released state). Correspondingly, the restoring forces RK1, RK2 are oriented toward each other.

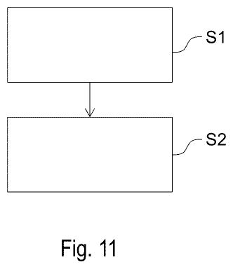

FIG. 11 shows a flowchart of one embodiment of the method.

In a step S1, the filter element 8 is inserted into the filter housing 7.

In a step S2, the engagement elements 23a, 23b are engaged with the corresponding engagement element counterparts 24a, 24b, wherein at least the restoring force RK1 (see, for example, FIG. 9D with an elastic element 28b) or two restoring forces RK1, RK2 (see, for example, FIG. 9B and 5F with two elastic elements 28a, 28b) are acting. Bending moments or tensile forces/compression forces resulting from the restoring forces RK1, RK2 are absorbed in the rigid element 27a so that the lateral band 11 does not bend or bends only insignificantly.

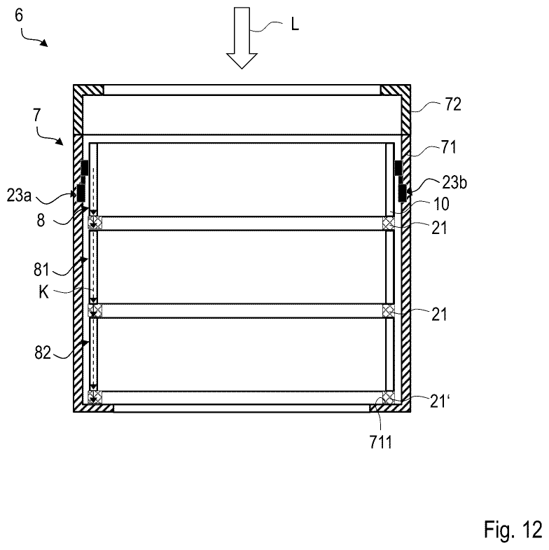

In FIG. 12, a longitudinal section of a multi-stage filter device 6 according to the invention is illustrated. It comprises a filter element 8 according to the invention as well as at least one further filter element 81. In embodiments, the multi-stage filter element 6 comprises two or more further filter elements 81, 82. The at least two filter elements 8, 81, 82 are flowed through in series, for example, in flow direction L. At least one of the filter elements 8, 81, 82 may comprise a gas filter medium comprising at least one adsorbent. A further one of the filter elements 8, 81, 82 may be a particle filter medium, for example comprising a HEPA filter medium. The multi-stage filter device 6 is suitable for example for use as an intake air filter of a fuel cell system or as a cabin air filter of a motor vehicle.

The filter element 8 according to the invention is held in the here described manner by its engagement elements 23a, 23b in corresponding engagement element counterparts 24a, 24b of the filter housing 7. In the embodiment provided only as an example, the housing-associated engagement element counterparts are provided at a first housing part 71 which provides a receptacle for the filter element 8 according to the invention. Furthermore, the first housing part 71 may also provide a receptacle for at least one further filter element 81, 82. The filter housing 7 comprises, in addition to the first housing part 71 which may be for example a housing base, a second housing part 72 which may be for example a housing cover.

The filter element 8 according to the invention is only indirectly sealed in relation to the filter housing 7 by the further filter element 81, for example by the further filter elements 81, 82. In this context, a frame 10 of the filter element 8 according to the invention rests seal-tightly at the second filter element 81, for example at its frame. A seal 21 may be positioned therebetween which, for example, may be held at the filter element 8 according to the invention or at the further filter element 81 or may be loosely inserted. The further filter element 81 in turn is resting in analogy seal-tightly at yet another filter element 82, which in turn is resting seal-tightly by a housing seal 21′, i.e., directly, at the filter housing 7, for example at the first housing part 71. In an embodiment which is not illustrated, the filter device 6 comprises precisely two filter elements, a filter element 8 according to the invention as well as only one further filter element 81. In this case, the housing seal 21′ is present between the further filter element 81 and the filter housing 7.

The seals 21, 21′ may be for example axial seals. The filter element 8 according to the invention may be inserted for example in such a way into the housing 7 that the seals 21 are pretensioned. A force course of the seal force K is schematically indicated with arrows. The force course of the seal force K extends, beginning at the engagement of the engagement elements 23a, 23b of the filter element 8 according to the invention, through the frame 10 of the filter element 8 according to the invention, the seal 21 between the filter element 8 according to the invention and the further filter element 81, the frame of the further filter element 81, the seal between the further filter element 81 and the still further filter element 82, the frame of the still further filter element 82 into the housing seal 21, where it finally effects as an effective seal force the sealing action of the still further filter element 82 in relation to the housing 7 so that the totality of the filter elements 8, 81, 82 are sealed indirectly in relation to the housing 7.

The housing comprises a housing seal surface 711 at which the housing seal 21′ rests seal-tightly. The housing seal surface 711 is for example designed as an axial seal surface.

Even though the present invention has been explained in more detail with the aid of preferred embodiments, it is not limited thereto but may be modified in many ways.

Reference Characters

| | |
|---|---|
| 1 | motor vehicle |
| 2 | air conditioning device |
| 3 | ambient air |
| 4 | air |
| 5 | cabin |
| 6 | filter device |
| 7 | filter housing |
| 71 | first housing part |
| 711 | housing seal surface |
| 72 | second housing part |
| 8 | interior filter/filter element |
| 81, 82 | further filter element |
| 9 | filter medium/filter medium body |
| 10 | frame |
| 11 | lateral band |
| 12 | lateral band |
| 13 | head band |
| 14 | head band |
| 15 | fold |
| 15a | fold section |
| 16 | fold edge |
| 17 | end fold |
| 18 | end fold |
| 19 | fold end face edge |
| 20 | fold end face edge |
| 21 | seal |
| 21′ | housing seal |
| 22 | side face |
| 23a-23d | engagement element |
| 24a-24d | engagement element counterpart |
| 25a, 25b | protrusion |
| 26a, 26b | wall |
| 27a, 27b | rigid element |
| 28a, 28b | elastic element |
| 29a, 29b | socket |
| 30a, 30b | insertion section |
| 31a, 31b | locking section |
| 32a, 32b | incline |
| 33 | rim |
| 34a-34d | opening |
| 35a, 35b | undercut |
| 36b | incline |
| 37b | undercut |
| 38b | wall |
| 39 | pocket |
| 40 | rigid section |
| 41a, 41b | frame |
| 42a, 42b | window |
| 43a, 43b | end of elastic element |
| 44a, 44b | frame element |
| 46a, 46b | guide section |
| 47a, 47b | guide counter section |
| 49a, 49b | cover plate |
| 50 | frame |
| 50a, 50b | opening |
| 51a-51d | frame elements |
| 52a, 52b | plates |
| A1, A2 | distances |
| BA | bending axis |
| D1 | distance in released state |
| D2 | distance in locked state |
| D3 | distance in undeformed state |
| E | plane |
| H | height of folds |
| H1, H2 | main extension plane |
| M | machine direction |
| L | flow direction |
| LE | length extension direction |
| RE | clean side/outflow side |
| RK1, RK2 | restoring force |
| RO | raw side/inflow side |
| S1, S2 | step |
| SY1-SY4 | symmetry axis |
| K | force course of the seal pretension forces |

What is claimed is:

1. A filter element comprising:
a filter medium body;
a frame at least partially surrounding the filter medium body and comprising a side face;
two engagement elements arranged at the side face of the frame, wherein the two engagement elements extend away from the filter medium body and are configured to engage in a locked state correlated engagement element counterparts at a filter housing to fasten the filter element to the filter housing;
a rigid element connecting the two engagement elements at the side face in a force-conducting manner to each other;
wherein the two engagement elements are configured to be disengaged in a released state thereof from the correlated engagement element counterparts, wherein the two engagement elements have a first distance relative to each other in the released state and have a second distance relative to each other in the locked state, wherein the second distance is different from the first distance;
wherein a first one of the two engagement elements is connected by a first elastic element to the rigid element;
wherein the first elastic element, when the two engagement elements transition from the locked state into the released state, generates a first restoring force and the first restoring force acts on the first one of the two engagement elements.

2. The filter element according to claim 1, wherein a second one of the two engagement elements is connected to the rigid element by a second elastic element, wherein the second elastic element, when the two engagement elements transition from the locked state into the released state, generates a second restoring force and the second restoring force acts on the second one of the two engagement elements.

3. The filter element according to claim 2, wherein the first restoring force and the second restoring force are oriented toward each other or are oriented opposite to each other.

4. The filter element according to claim 2, wherein at least one of the first elastic element and the second elastic element is configured to generate the first restoring force or the second restoring force, respectively, by a bending-elastic deformation thereof.

5. The filter element according to claim 4, wherein the rigid element is a bending-resistant element.

6. The filter element according to claim 5, wherein the rigid element comprises a greater tensile stiffness/compression strength or bending stiffness than at least one of the first elastic element and the second elastic element.

7. The filter element according to claim 2, wherein at least one of the first elastic element and the second elastic element is fastened to the rigid element and/or to the frame.

8. The filter element according to claim 2, wherein at least one of the first elastic element and the second elastic element is formed as one piece together with the rigid element and/or the frame.

9. The filter element according to claim 2, wherein at least one of the first elastic element and the second elastic element is fastened by a socket to the frame and/or to the rigid element, and wherein at least one of the first elastic element and the second elastic element is oriented along a flow direction of the filter element or at an acute angle to the flow direction of the filter element.

10. The filter element according to claim 9, wherein the at least one of the first elastic element and the second elastic element extends parallel to and spaced apart from the side face of the frame and/or the rigid element.

11. The filter element according to claim 1, wherein the two engagement elements are mirror-symmetrical to each other in relation to a symmetry axis oriented in a flow direction of the filter element.

12. A filter device comprising:
a filter element according to claim 1; and
a filter housing, wherein the filter element is fastened to the filter housing, and wherein the two engagement elements of the filter element engage correlated engagement element counterparts of the filter housing.

13. The filter device according to claim 12, wherein the correlated engagement element counterparts include an engagement element counterpart correlated with a first one of the two engagement elements, wherein the engagement element counterpart correlated with the first one of the two engagement elements comprises an insertion section and a locking section, wherein the first one of the two engagement elements is configured to be guided, when fastening the filter element to the filter housing, through the insertion section and into the locking section, and wherein the first restoring force secures the first one of the two engagement elements in the locking section against disengagement therefrom.

14. The filter device according to claim 13, wherein the insertion section is configured to counteract the first restoring force in order to change the distance between the two engagement elements.

15. The filter device according to claim 13, wherein the correlated engagement element counterparts each comprise a locking section, wherein the locking sections are oriented away from each other or toward each other and are mirror-symmetrical in relation to a symmetry axis extending in a flow direction of the first filter element.

16. The filter device according to claim 15, wherein the insertion section comprises a section acting as an incline on the first one of the two engagement elements, wherein the locking section forms an undercut at an end of the incline.

17. The filter device according to claim 16, wherein, in relation to a flow direction of the filter element, the incline is oriented at a slant to the flow direction of the first filter element and/or the undercut extends transversely to the flow direction of the first filter element.

18. A vehicle comprising a filter device comprising a filter housing and a filter element according to claim 1, wherein the filter element is fastened to the filter housing, wherein the two engagement elements of the filter element engage correlated engagement element counterparts of the filter housing.

19. A method of using a filter element according to claim 1 in a filter device, the method comprising engaging the two engagement elements of the filter element with correlated engagement element counterparts of a filter housing of the filter device.

20. A method for fastening a filter element in a filter housing, wherein the filter element comprises a filter body and a frame surrounding at least partially circumferentially the filter body, the method comprising:
inserting the filter element into the filter housing; and
engaging two engagement elements of the filter element, arranged at a side face of the frame of the filter element and connected force-conductingly to each other by a rigid element at the side face, with correlated engagement element counterparts of the filter housing with a change of a distance between the two engagement elements and applying by an elastic element, connecting one of the two engagement elements to the rigid element, a restoring force on said one engagement element upon the change of the distance.
